(19) United States
(12) Patent Application Publication
(10) Pub. No.: US 2023/0172160 A1
(43) Pub. Date: Jun. 8, 2023

(54) Animal Water Reservoir with Replaceable Inserts

(71) Applicant: Aaron Stephen Hedge, Bentonville, AR (US)

(72) Inventor: Aaron Stephen Hedge, Bentonville, AR (US)

(21) Appl. No.: 18/047,308

(22) Filed: Oct. 18, 2022

Related U.S. Application Data
(60) Provisional application No. 63/285,784, filed on Dec. 3, 2021.

(51) Int. Cl. A01K 7/06

(52) U.S. Cl. CPC A01K 7/06

(57) ABSTRACT

An animal drinking reservoir with replaceable inserts is presented. The animal drinking reservoir with replaceable inserts consists of a reservoir body and a replaceable reservoir insert. The reservoir body serves as a mounting fixture that attaches along a hamster case or any other suitable surface or body. The replaceable reservoir insert is installed along the mounting fixture, where the replaceable reservoir serves as a water dispensing unit suitable for supplying drinking water for animals. Once the reservoir insert is due for a water change, a user can easily swap the spend reservoir insert with a fresh reservoir insert.

### FIELD OF THE INVENTION

The present invention relates generally to drinking reservoirs, specifically animal drinking reservoirs with replaceable inserts.

### BACKGROUND OF THE INVENTION

Pets that reside in cages are often supplied with a hanging water bottle fixture that dispenses drinking water. Hamster cages specifically have a water bottle that is directly attached to the hamster cage. A user will have to detach the water bottle from the hamster cage to refill the bottle, which can prove challenging for users with disabilities or movement impaired users. Additionally, detaching the water bottle from the cage may prove to be an inconvenience for some users. Therefore, it is an objective of the present invention to provide a quick and easy means of facilitating water changes along a hamster cage.

The present invention aims to solve these problems and inconveniences. The present invention features a mounting fixture that supports replaceable reservoir inserts. The mounting fixture is fixed along the hamster cage. The replaceable reservoir insert is then installed in the mounting fixture, where the replaceable reservoir insert is configured to dispense water. Once the user needs to perform a water change, the user simply needs to remove the spent replaceable reservoir and replace it with a fresh one. This provides a quick and easy means of facilitating water changes along a hamster cage.

### SUMMARY OF THE INVENTION

The present invention is an animal water reservoir with replaceable inserts. In the preferred embodiment, the animal water reservoir with replaceable inserts allows the user to easily monitor and make water changes in order to supply fresh water for their pet. In the preferred embodiment, the animal water reservoir takes the form of a hamster style water feeder but may be adapted to any form suitable for a variety of applications. In the preferred embodiment, the animal water reservoir with replaceable inserts is made out of any suitable material, such as, but not limited to plastic polymers, food grade materials, aluminum, stainless steel, or any other suitable materials. The animal water reservoir with replaceable inserts comprises a reservoir body and a reservoir insert. The reservoir body comprises a mounting body, a reservoir receiving cavity, and a tip channel. The reservoir insert comprises a reservoir vessel, a nozzle mounting element, and a nozzle insert.

In the preferred embodiment, the reservoir body takes the form of the main chassis of the animal water reservoir with replaceable insert that supports and secures the components the constitutes the animal water reservoir with replaceable inserts. In the preferred embodiment, the reservoir body is made out of a transparent material, allowing the user to visualize the water level. In the preferred embodiment, the reservoir insert takes the form of a replaceable water supply insert that installs along the reservoir body, facilitating quick and easy water changes. In the preferred embodiment, the reservoir insert is also made out of a transparent material, allowing the user to visualize the water level. In one embodiment, the reservoir insert takes the form of a rigid and refillable water bottle that installs along the reservoir body for quick and easy water replacement. In another embodiment, the reservoir takes the form of a flexible and refillable reservoir bag. In the preferred embodiment, the mounting body takes the form of the mounting portion of the reservoir body, where the mounting body is configured to attach and mount along a hamster cage or any other suitable surface or body. In the preferred embodiment, the mounting body is cylindrical in shape, but can take form of any other suitable shape. In the preferred embodiment, the reservoir receiving cavity takes the form of a receiving cavity within the mounting body, where the reservoir receiving cavity is configured to receive, secure, and position the reservoir insert along the hamster cage that the reservoir is installed along. In the preferred embodiment, the tip channel takes the form of a clearance channel that allows the nozzle insert to slide and install along the reservoir body.

### BRIEF DESCRIPTION OF THE DRAWINGS

FIG. 1 is a perspective view of the present invention installed along a hamster cage.

FIG. 2 is a front perspective view of the present invention.

FIG. 3 is a front perspective exploded view of the present invention.

FIG. 4 is rear perspective exploded view of the present invention.

FIG. 5 is a top side view of the present invention.

FIG. 6 is cross sectional view of the present invention taken along cutting lines A-A in FIG. 5.

FIG. 7 is a diagram view showing a reservoir body being filled along a faucet.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

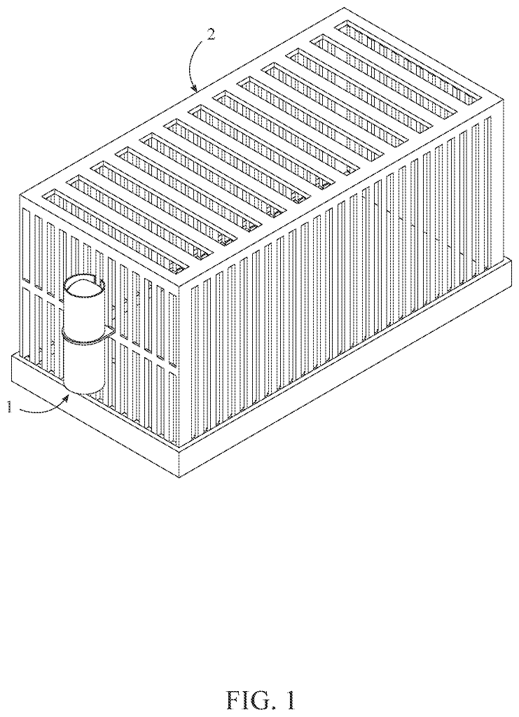

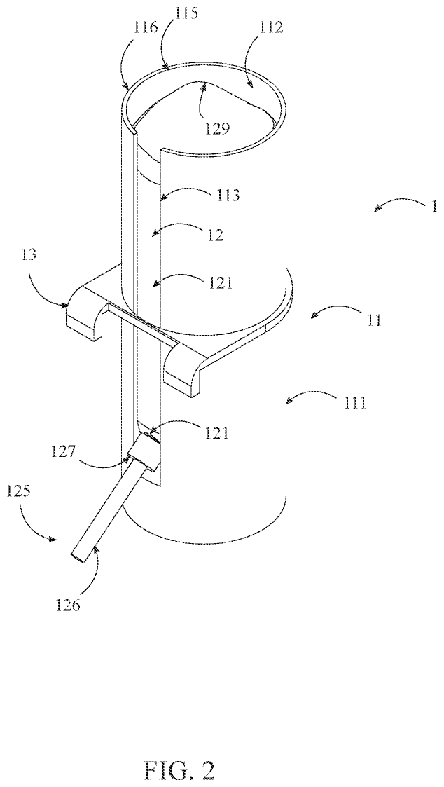

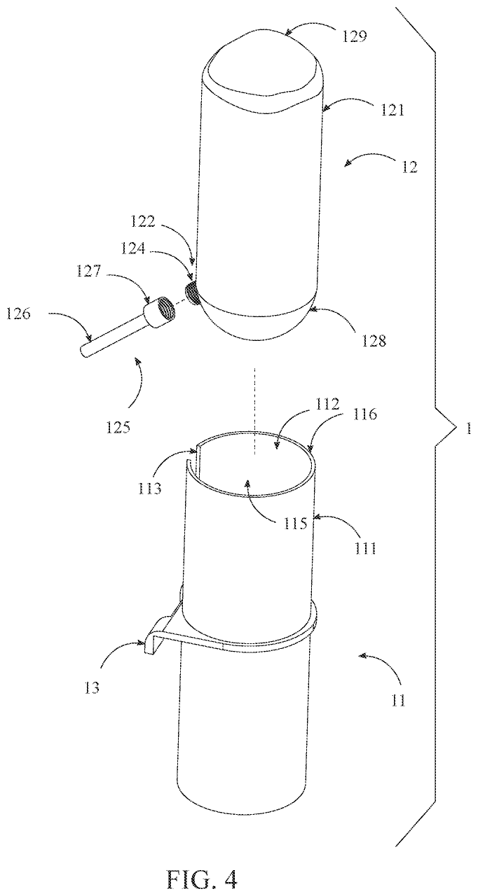

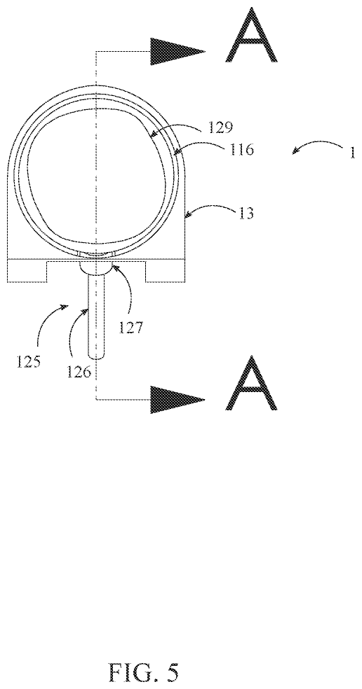

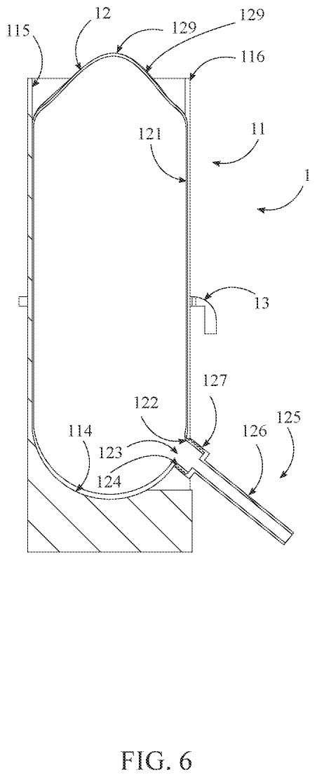

In reference to FIGS. 1-6, the present invention is an animal water reservoir with replaceable inserts 1. In the preferred embodiment, the animal water reservoir with replaceable inserts 1 allows the user to easily monitor and make water changes in order to supply fresh water for their pet. In the preferred embodiment, the animal water reservoir takes the form of a hamster style water feeder but may be adapted to any form suitable for a variety of applications. In the preferred embodiment, the animal water reservoir with replaceable inserts 1 is made out of any suitable material, such as, but not limited to plastic polymers, food grade materials, aluminum, stainless steel, or any other suitable materials. In reference to FIGS. 2-6, the animal water reservoir with replaceable inserts 1 comprises a reservoir body 11 and a reservoir insert 12. In reference to FIGS. 2-4 and 6, the reservoir body 11 comprises a mounting body 111, a reservoir receiving cavity 112, and a tip channel 113. In reference to FIGS. 2-6, the reservoir insert 12 comprises a reservoir vessel 121, a nozzle mounting element 122, and a nozzle insert 125.

In the preferred embodiment, the reservoir body 11 takes the form of the main chassis of the animal water reservoir with replaceable insert that supports and secures the components the constitutes the animal water reservoir with replaceable inserts 1. In the preferred embodiment, the reservoir body 11 is made out of a transparent material, allowing the user to visualize the water level. In the preferred embodiment, the reservoir insert 12 takes the form of a replaceable water supply insert that installs along the reservoir body 11, facilitating quick and easy water changes. In the preferred embodiment, the reservoir insert 12 is also made out of a transparent material, allowing the user to visualize the water level. In one embodiment, the reservoir insert 12 takes the form of a rigid and refillable water bottle that installs along the reservoir body 11 for quick and easy water replacement. In another embodiment, the reservoir takes the form of a flexible and refillable reservoir bag. In the preferred embodiment, the mounting body 111 takes the form of the mounting portion of the reservoir body 11, where the mounting body 111 is configured to attach and mount along a hamster cage 2 or any other suitable surface or body. In the preferred embodiment, the mounting body 111 is cylindrical in shape, but can take form of any other suitable shape. In the preferred embodiment, the reservoir receiving cavity 112 takes the form of a receiving cavity within the mounting body 111, where the reservoir receiving cavity 112 is configured to receive, secure, and position the reservoir insert 12 along the hamster cage 2 that the reservoir is installed along. In the preferred embodiment, the tip channel 113 takes the form of a clearance channel that allows the nozzle insert 125 to slide and install along the reservoir body 11.

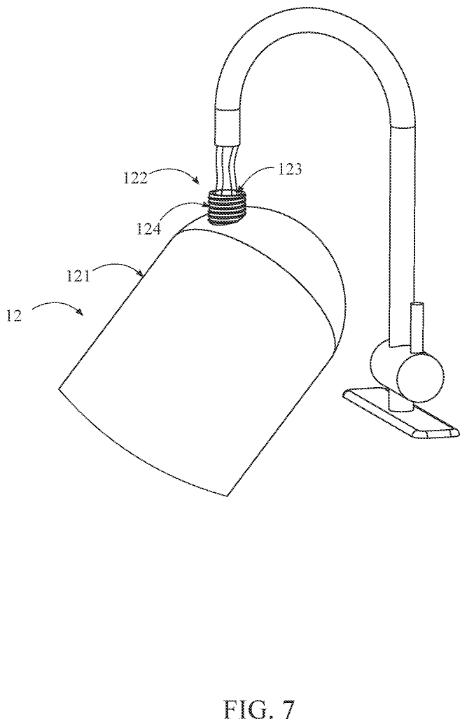

In the preferred embodiment, the reservoir vessel 121 takes the form of any suitable fluid vessel that facilitates the storage of drinking water. In the preferred embodiment, the nozzle mounting element 122 takes the form of any suitable mounting element 13 integrated along the reservoir vessel 121 such that the nozzle insert 125 installs along the nozzle mounting element 122. Additionally, the nozzle mounting element 122 serves as the fluid dispensing portion of the reservoir body 11, where the nozzle mounting element 122 is configured to allow water to pass in or out of the reservoir vessel 121, respectively allowing for refills, as shown in FIG. 7. In one embodiment, the nozzle mounting element 122 takes the form of a threaded collar style mounting element 13 but may take the form of any other suitable mounting implement. In the preferred embodiment, the nozzle insert 125 takes the form of a removably attached drinking nozzle implement suited for hamsters but may take the form of any other suitable drinking nozzle suitable for a variety of applications.

The nozzle mounting element 122 is connected adjacent to the reservoir insert 12, where the nozzle mounting element 122 is configured to be sealed along the reservoir insert 12. The nozzle mounting element 122 is in fluid communication with the reservoir vessel 121, where the nozzle mounting element 122 is configured to allow drinking water to dispense in or out of the reservoir vessel 121. The nozzle insert 125 is connected adjacent to the nozzle mounting element 122, where the nozzle insert 125 is removably attached to the nozzle mounting element 122 to facilitate the ability to refill the reservoir vessel 121, as shown in FIG. 7. The nozzle insert 125 is in fluid communication with the reservoir vessel 121. The reservoir receiving cavity 112 traverses into the mounting body 111, where the reservoir receiving cavity 112 is configured to receive and position the reservoir insert 12 and the nozzle insert 125 to a sufficient height suitable for hamsters or any other animal. The tip channel 113 traverses along the reservoir receiving cavity 112, wherein the tip channel 113 is configured to provide ample clearance for the nozzle insert 125 to freely slide and install along the reservoir body 11. The reservoir insert 12 is removably attached within the reservoir receiving cavity 112. The nozzle insert 125 is positioned within the tip channel 113.

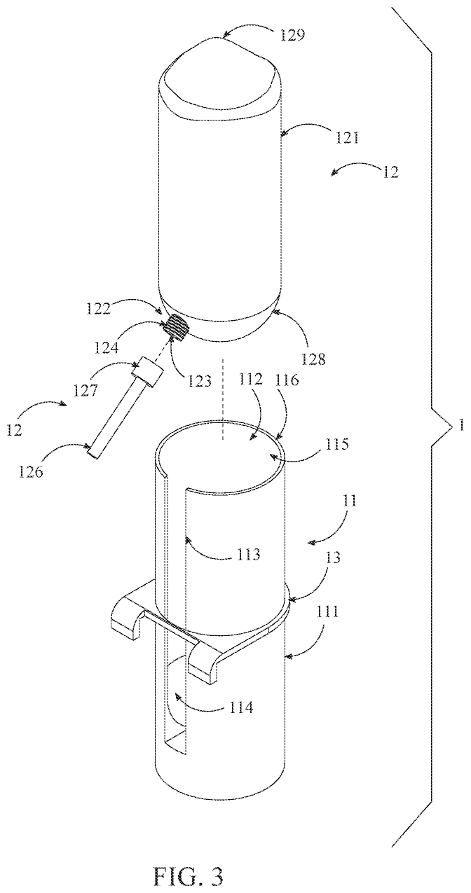

In reference to FIGS. 2-6, the reservoir body 11 further comprises a receiving base 114, a reservoir partition 115 and a reservoir brim 116. In the preferred embodiment, the receiving base 114 takes the form of interior bottom portion of the reservoir body 11 that allows the reservoir insert 12 to install and secure along the reservoir cavity. In one embodiment, the receiving base 114 takes the form of a concaved bottom to facilitate the reservoir bag embodiment of the reservoir insert 12, where the concaved bottom of the receiving base 114 is configured to prevent the reservoir bag from buckling into itself, allowing the water within the reservoir vessel 121 to dispense freely. In the preferred embodiment, the reservoir partition 115 takes the form of the raise interior walls of the reservoir body 11, where the reservoir partition 115 is configured to hold the reservoir insert 12 in place along the reservoir cavity. In the preferred embodiment, the reservoir brim 116 takes the form of the open top portion of the reservoir body 11, where the reservoir brim 116 is configured to serve as an access opening, allowing the user to access the reservoir insert 12 along the reservoir brim 116 portion of the reservoir body 11 for water changes. The reservoir partition 115 is positioned within the mounting body 111. The receiving base 114 and the reservoir brim 116 are positioned terminally opposite to each other along the reservoir partition 115. In reference to FIGS. 3-6, the reservoir insert 12 further comprises an insert base 128 and an insert top 129. In the preferred embodiment, the insert base 128 takes the form of the bottom portion of the reservoir insert 12 while the insert top 129 takes the form of the top portion of the reservoir insert 12. The insert base 128 and the insert top 129 are positioned terminally opposite to each other along the reservoir insert 12. The nozzle mounting insert is connected between the insert base 128 and the insert top 129. The insert base 128 is positioned adjacent to the receiving base 114. The insert top 129 is positioned adjacent to the reservoir brim 116.

In reference to FIGS. 2-6, the animal water reservoir with replaceable inserts 1 further comprises a mounting element 13. The mounting element 13 is connected adjacent to the reservoir body 11. In the preferred embodiment, the mounting element 13 takes the form of any suitable mounting element 13, where the mounting element 13 is configured to attach and mount the reservoir body 11 along the hamster cage 2 or any other suitable surface or body. In one embodiment, the mounting element 13 takes the form of a C-bracket with a set of hooks that wraps around the mounting body 111, where the set of hooks attaches along the hamster cage 2 but can take the form of any other suitable mounting element 13.

In reference to FIGS. 2-6, the nozzle mounting element 122 comprises a fluid aperture 123 and a nozzle fastener 124. The fluid aperture 123 takes the form of a dispensing opening installed along the reservoir insert 12 that allows drinking water to pass in or out of the reservoir insert 12. The nozzle fastener 124 takes the form of any suitable fastening implement suitable for attaching the nozzle insert 125 along the fluid aperture 123. In the preferred embodiment, the nozzle fastener 124 takes the form of a threaded collar. The fluid aperture 123 traverses through the reservoir insert 12. The nozzle fastener 124 is concentrically aligned to the fluid aperture 123. The nozzle fastener 124 is connected adjacent to the fluid aperture 123. In reference to FIGS. 2-6, the nozzle insert 125 comprises a nozzle tip 126 and an insert fastener 127. In the preferred embodiment, the nozzle tip 126 takes the form of any suitable drinking nozzle tip 126 that allows hamsters to drink water from the nozzle insert 125 but can takes the form of any other suitable nozzle tip 126. In the preferred embodiment, the insert fastener 127 takes the form of a threaded coupler that installs the nozzle tip 126 along the nozzle fastener 124. The nozzle tip 126 is connected adjacent to the insert fastener 127. The insert fastener 127 is removably attached to the nozzle fastener 124.

Although the invention has been explained in relation to its preferred embodiment, it is to be understood that many other possible modifications and variations can be made without departing from the spirit and scope of the invention as hereinafter claimed.

What is claimed is:

1. An animal water reservoir with replaceable inserts comprising:
a reservoir body;
a reservoir insert;
the reservoir body comprising a mounting body, a reservoir receiving cavity, and a tip channel;
the reservoir insert comprising a reservoir vessel, a nozzle mounting element, and a nozzle insert;
the nozzle mounting element being connected adjacent to the reservoir insert;
the nozzle mounting element being in fluid communication with the reservoir vessel;
the nozzle insert being connected adjacent to the nozzle mounting element;
the nozzle insert being in fluid communication with the reservoir vessel;
the reservoir receiving cavity traversing into the mounting body;
the tip channel traversing along the reservoir receiving cavity;
the reservoir insert being removably attached within the reservoir receiving cavity; and
the nozzle insert being positioned within the tip channel.

2. The animal water reservoir with replaceable inserts as claimed in claim 1 comprising:
the reservoir body further comprising a receiving base, a reservoir partition, and a reservoir brim;
the reservoir partition being positioned within the mounting body; and
the receiving base and the reservoir brim being positioned terminally opposite to each other along the reservoir partition.

3. The animal water reservoir with replaceable inserts as claimed in claim 2 comprising:
the reservoir insert further comprising an insert base and an insert top;
the insert base and the insert top being positioned terminally opposite to each other along the reservoir insert;
the nozzle mounting insert being connected between the insert base and the insert top;
the insert base being positioned adjacent to the receiving base; and
the insert top being positioned adjacent to the reservoir brim.

4. The animal water reservoir with replaceable inserts as claimed in claim 1 comprising:
a mounting element; and
the mounting element being connected adjacent to the reservoir body.

5. The animal water reservoir with replaceable inserts as claimed in claim 1 comprising:
the nozzle mounting element comprising a fluid aperture and a nozzle fastener;
the fluid aperture traversing through the reservoir insert;
the nozzle fastener being concentrically aligned to the fluid aperture; and
the nozzle fastener being connected adjacent to the fluid aperture.

6. The animal water reservoir with replaceable inserts as claimed in claim 5 comprising:
the nozzle insert comprising a nozzle tip and an insert fastener;
the nozzle tip being connected adjacent to the insert fastener; and
the insert fastener being removably attached to the nozzle fastener.

7. The animal water reservoir with replaceable inserts as claimed in claim 1, wherein the reservoir body is made out of a transparent material.

8. The animal water reservoir with replaceable inserts as claimed in claim 1, wherein the reservoir insert is made out of a transparent material.

9. The animal water reservoir with replaceable inserts as claimed in claim 3, wherein the reservoir insert is a reservoir bag.

10. The animal water reservoir with replaceable inserts as claimed in claim 1, wherein the reservoir insert is a reservoir bottle.

11. An animal water reservoir with replaceable inserts comprising:
a reservoir body;
a reservoir insert;
the reservoir body comprising a mounting body, a reservoir receiving cavity, a tip channel, a receiving base, a reservoir partition, and a reservoir brim;
the reservoir insert comprising a reservoir vessel, a nozzle mounting element, and a nozzle insert;
the nozzle mounting element being connected adjacent to the reservoir insert;
the nozzle mounting element being in fluid communication with the reservoir vessel;
the nozzle insert being connected adjacent to the nozzle mounting element;
the nozzle insert being in fluid communication with the reservoir vessel;
the reservoir receiving cavity traversing into the mounting body;
the tip channel traversing along the reservoir receiving cavity;
the reservoir insert being removably attached within the reservoir receiving cavity;
the nozzle insert being positioned within the tip channel;
the reservoir partition being positioned within the mounting body; and
the receiving base and the reservoir brim being positioned terminally opposite to each other along the reservoir partition.

12. The animal water reservoir with replaceable inserts as claimed in claim 11 comprising:
the reservoir insert further comprising an insert base and an insert top;
the insert base and the insert top being positioned terminally opposite to each other along the reservoir insert;
the nozzle mounting insert being connected between the insert base and the insert top;
the insert base being positioned adjacent to the receiving base; and
the insert top being positioned adjacent to the reservoir brim.

13. The animal water reservoir with replaceable inserts as claimed in claim 11 comprising:
a mounting element; and
the mounting element being connected adjacent to the reservoir body.

14. The animal water reservoir with replaceable inserts as claimed in claim 11 comprising:
the nozzle mounting element comprising a fluid aperture and a nozzle fastener;
the fluid aperture traversing through the reservoir insert;
the nozzle fastener being concentrically aligned to the fluid aperture; and
the nozzle fastener being connected adjacent to the fluid aperture.

15. The animal water reservoir with replaceable inserts as claimed in claim 14 comprising:
the nozzle insert comprising a nozzle tip and an insert fastener;
the nozzle tip being connected adjacent to the insert fastener; and
the insert fastener being removably attached to the nozzle fastener.

16. The animal water reservoir with replaceable inserts as claimed in claim 11, wherein the reservoir body is made out of a transparent material.

17. The animal water reservoir with replaceable inserts as claimed in claim 11, wherein the reservoir insert is made out of a transparent material.

18. The animal water reservoir with replaceable inserts as claimed in claim 11, wherein the reservoir insert is a reservoir bag.

19. An animal water reservoir with replaceable inserts comprising:
a reservoir body;
a reservoir insert;
the reservoir body comprising a mounting body, a reservoir receiving cavity, a tip channel, a receiving base, a reservoir partition, and a reservoir brim;
the reservoir insert comprising a reservoir vessel, a nozzle mounting element, a nozzle insert, an insert base and an insert top;
the nozzle mounting element being connected adjacent to the reservoir insert;
the nozzle mounting element being in fluid communication with the reservoir vessel;
the nozzle insert being connected adjacent to the nozzle mounting element;
the nozzle insert being in fluid communication with the reservoir vessel;
the reservoir receiving cavity traversing into the mounting body;
the tip channel traversing along the reservoir receiving cavity;
the reservoir insert being removably attached within the reservoir receiving cavity;
the nozzle insert being positioned within the tip channel;
the reservoir partition being positioned within the mounting body;
the receiving base and the reservoir brim being positioned terminally opposite to each other along the reservoir partition;
the insert base and the insert top being positioned terminally opposite to each other along the reservoir insert;
the nozzle mounting insert being connected between the insert base and the insert top;
the insert base being positioned adjacent to the receiving base; and
the insert top being positioned adjacent to the reservoir brim.

20. The animal water reservoir with replaceable inserts as claimed in claim 19 comprising:
the nozzle mounting element comprising a fluid aperture and a nozzle fastener;
the nozzle insert comprising a nozzle tip and an insert fastener;
the fluid aperture traversing through the reservoir insert;
the nozzle fastener being concentrically aligned to the fluid aperture;
the nozzle fastener being connected adjacent to the fluid aperture;
the nozzle tip being connected adjacent to the insert fastener; and
the insert fastener being removably attached to the nozzle fastener.
